(19) United States
(12) Patent Application Publication
(10) Pub. No.: US 2008/0086828 A1
(43) Pub. Date: Apr. 17, 2008

(54) Multiside roller brush

(76) Inventor: Willis Gerald Major, Rochester, NY (US)

Correspondence Address: Willis Major, PO box 13655, Rochester, NY, 14613, US

(21) Appl. No.: 11/549,522

(22) Filed: Oct. 13, 2006

(51) Int. Cl. B05C 17/02

(52) U.S. Cl. 15/230.11; 492/19

(57) ABSTRACT

A multisided roller brush that can surround and act on the entire surface area of multisided objects comprising bars, posts, poles, shafts, spindles, railings, supports, and columns, but not limiting to the aforementioned group of multisided objects, while the operator is positioned on only one side of said multisided objects for purposes comprising painting, staining, dusting, polishing, striping, sanding, cleaning, wiping off or applying chemicals (liquid and powder), comprising a one piece frame and two rollers where the frame and rollers are in the same plane and the center line of the 90 degree angle formed by the rollers is 90 degrees to the center line of the frame handle.

### CROSS-REFERENCE TO RELATED APPLICATIONS

Not applicable

### BACKGROUND

1. Field of Invention

This invention relates to “multi rollers” that are used to paint, stain, dust, polish, strip, sand, clean, wipe off & apply chemicals (liquid and powder) to the surface area of multisided objects comprising of bars, posts, poles, shafts, spindles, railings, supports, and columns but not limiting to the aforementioned group of objects.

2. Description of Prior Art

The popular method of painting, staining, dusting, polishing, striping, cleaning, wiping off & applying chemicals to the surface area of multisided objects is to use a standard brush that has a handle at one end and brush material pointing 180 degrees straight out of the opposite end of handle or using a standard roller that has a handle located 90 degree to the roller. With this current method one is restricted to starting at zero degrees and brushing or rolling up, down, and around multisided objects until 360 degrees is reached. This method is expensive and time consuming because it demands many strokes of the brush around the surface area of a multisided object and the operator must move around the multisided object in order to act on the entire surface area of said object. The applied coating is less uniform when using brushes and also displays brush marks.

Another method is to use of rollers to apply said coatings to multisided objects. Roller coating is quick, eliminates brush marks, and provides a more uniform coating. Most single rollers are designed for flat surfaces, so they are less adequate when applying coatings to multisided objects.

Prior art multi-roller devices have attempted to provide a solution to one or more problems envisioned herby include luliano et al (U.S. Pat. No. 5,035,022) which discloses three coactive rollers mounted on two fixed and one detachable and adjustable support axle. The paint applicator is expensive, has a complex adjustment process that is time consuming and does not allow for roller contact all around multisided objects while the operator remains on one side object.

Mclendon (U.S. Pat. No. 2,813,292) discloses two side rollers and a central roller operatively interposed therebetween for mainly painting cylindrical pipe. This paint applicator also requires adjustment, is expensive and does not allow for roller contact all around multisided objects while the operator remains on one side of said object.

Rivadeneira (U.S. Pat. No. 6,957,470 B2) discloses four replaceable rollers pivotally attached to a handle that provides for painting of the two adjoining surfaces forming a typical 90 degree interior corner. This paint applicator is use for interior corners and thus is not suitable for coating the exterior of multisided objects. This paint applicator also requires adjustment, is expensive and does not allow for roller contact all around multisided objects while the operator remains on one side of said object Kierce (U.S. Pat. No. 4,644,604) discloses two rollers disposed in spaced parallel relationship to each other on a flexible frame which the operator must apply compression pressure to bring the rollers in contact with opposite sides of the object being painted. This device leads to operator fatigue during extended operation, does not have the right roller angle to surround multiple railings, like on a porch and is expensive.

Parr (U.S. Pat. No. 3,358,312) discloses a four roller post painter where the rollers are mounted on a frame in a manner to completely encircle the object being painted. Parr's device must be disassembled each time the paint supply on the rollers need replenishing and is restricted to use on square and rectangular shaped post. The post must not be enclosed on both ends or Parr's paint applicator must be disassembled and reassembled around the post. This applicator is expensive and require adjustments.

Accordingly, in spite of the various efforts of the prior art, a need still exists for an improved device that is used to paint, stain, dust, polish, strip, sand, clean, wipe off & apply chemicals (liquid and powder) to the surface area of multisided objects comprising of bars, posts, poles, shafts, spindles, railings, supports, and columns in a manner that is easy & quick to use, low cost, and where the rollers can coat the multisided object as the operator stands on only one side of the object eliminating the need to waste time moving around the object to fully coat or impact the surface area of the object.

### SUMMARY

In accordance with the present invention, the “multisided roller brush” mainly comprises a frame and two rollers which are detachably mounted onto said frame.

The present invention allows the operator to just stand on one side of multisided objects while surrounding the object with the invention thus reducing the amount of time to cover the entire surface area of multisided objects, due to not having to walk around to the opposite side of the said object to cover the surface of the object with my invention. My invention reduces the amount of time to paint, stain, dust, polish, strip, sand, clean, wipe off & apply chemicals (liquid and powder) to the surface area of multisided objects comprising of bars, posts, poles, shafts, spindles, railings, supports, and columns but not limiting to the aforementioned group of objects. My invention is very quick and simple to manufacture making it much cheaper than other devices. The two individual and detachably mounted rollers on my invention can be covered with any suitable material designed to provide effective painting, staining, dusting, polishing, stripping, sanding, cleaning, wiping off & applying of liquid and power chemicals.

### OBJECTS AND ADVANTAGES

Accordingly, several objects and advantages of the “multisided roller brush” described in my above patent are:
(a) to provide a way to concurrently paint, stain, dust, polish, strip, sand, clean, wipe off or apply chemicals (liquid and powder) to different sides around the surface area of multisided objects comprising of bars, posts, poles, shafts, spindles, railings, supports, and columns but not limiting to the aforementioned group of objects;
(b) to provide a faster way to paint, stain, dust, polish, strip, sand, clean, wipe off or apply chemicals (liquid and powder) to multisided objects comprising bars, posts, poles, shafts, spindles, railings, supports, and columns but not limiting to the aforementioned group of objects;
(c) to provide a more efficient way of painting, staining, dusting, polishing, striping, sanding, cleaning, wiping off or applying chemicals (liquid and powder) to multisided objects comprising bars, posts, poles, shafts, spindles, railings, supports, and columns but not limiting to the aforementioned group of objects;
(d) to provide a cheaper way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(e) to provide an easier way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(f) to provide a simple way paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(g) to provide a reduction in the number of people require to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(h) to provide a better way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;

Further objectives and advantages of my invention will become apparent from a consideration of the drawings and ensuing description.

### DRAWING FIGURES

In accordance with the present invention a “multisided roller brush” mainly comprises a frame and two rollers which are detachably mounted onto said frame.

FIG. 1) shows the multi-roller brush frame with a roller attached using the barb retention end of the multi-roller brush frame to retain the roller.

FIG. 2) shows the multi-roller brush frame with a roller attached using a retainer internal to the roller to retain the roller.

FIG. 3) show the multi-roller brush frame with a roller attached using a nut threaded onto the end of the multi-roller brush frame to retain the roller.

FIG. 4) show the multi-roller brush frame with a press-fit retainer internal to the roller to retain the roller.

FIG. 5) shows the multi-roller brush frame with the barb retention end.

FIG. 6) shows the multi-roller brush frame with no retention end.

FIG. 7) show the multi-roller brush frame with a threaded retention end.

FIG. 8) shows round cross sectional shape of the multi-roller bush frame roller arms.

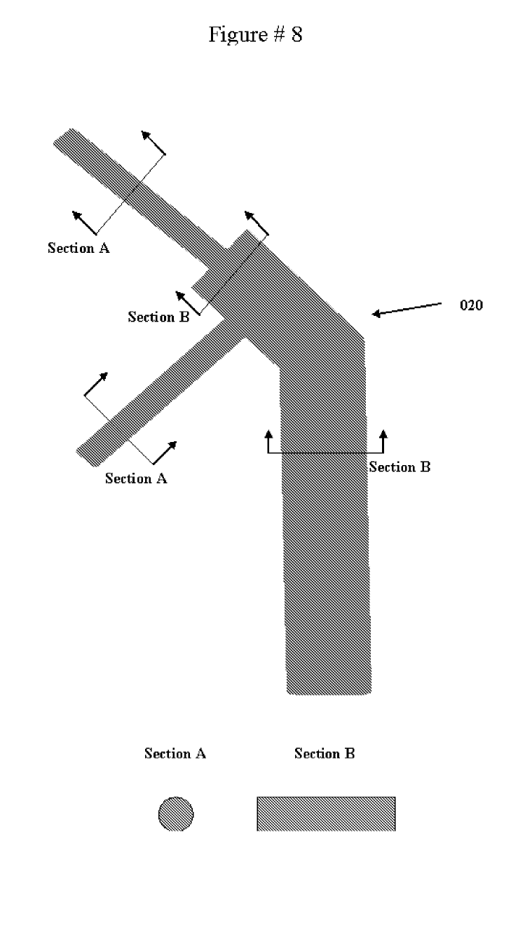

FIG. 9) shows rectangular cross sectional shape of the multi-roller bush frame roller arms.

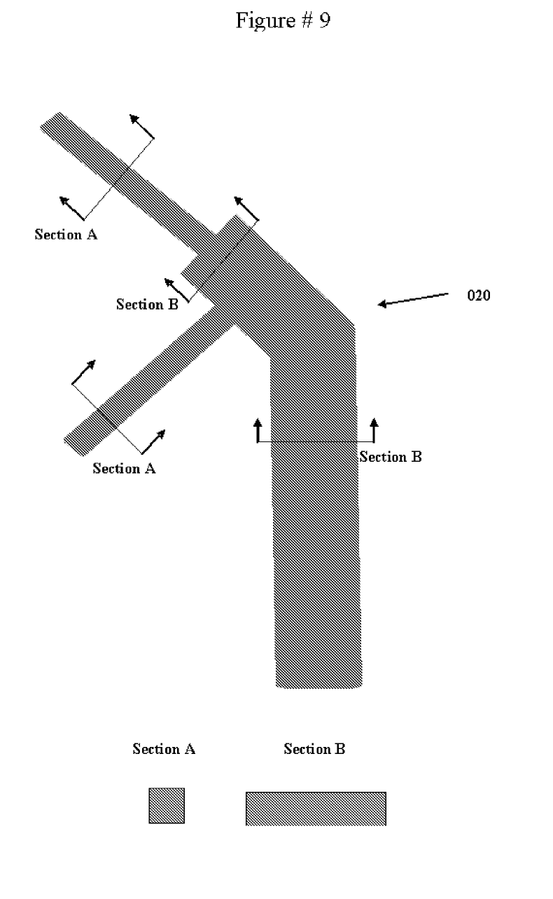

### REFERENCE NUMERALS IN DRAWINGS

010 multisided roller brush
020 frame
030 frame handle
040 frame handle & arm connection member
050 frame arm
060 frame left arm
070 frame right arm
080 frame arm roller connection means
090 frame arm barb connection end
100 frame arm threaded connection end
110 roller
120 roller material
130 roller painting material
140 roller staining material
150 roller sanding material
160 roller dusting material
170 roller polishing material
180 roller liquid chemical applying material
190 roller powder chemical applying material
200 roller stripping material
210 roller cleaning material
220 roller print material for identification or labeling
230 roller core
240 roller core inside surface
250 roller core outside surface
260 roller core hole
270 roller core internal retainer
280 roller core sleeve
290 roller with internal retainer for frame arm
300 roller with nut for retention on frame arm
310 roller for press-fit retention on frame arm
320 roller end plug
330 roller nut

### DESCRIPTION

### Preferred Multisided Roller Brush

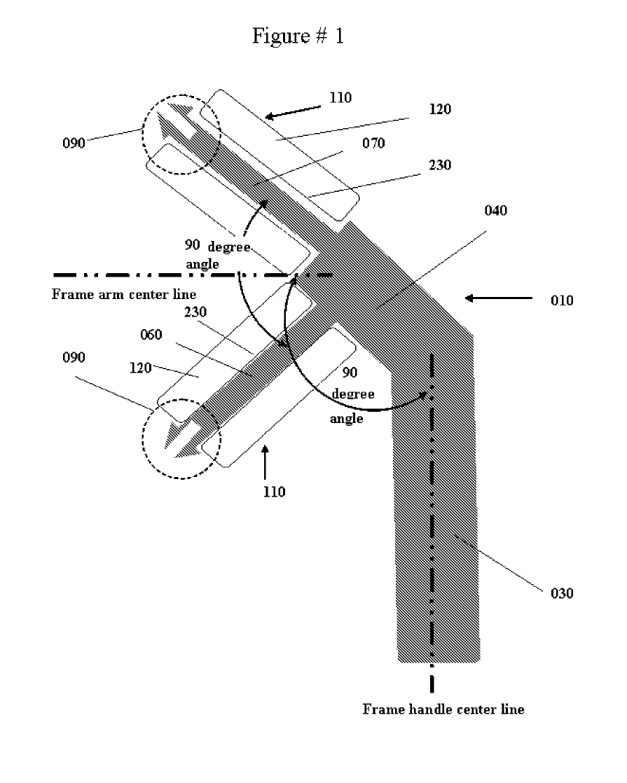

A preferred embodiment of the “multisided roller brush” is illustrated in FIG. 1. The “multisided roller brush 010” main parts generally comprise of a frame 020 and a pair of rollers 110.

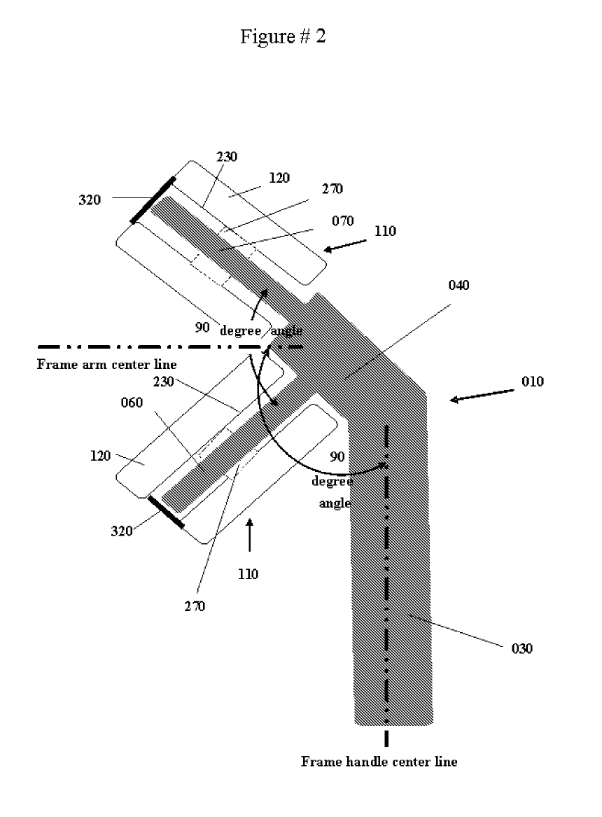

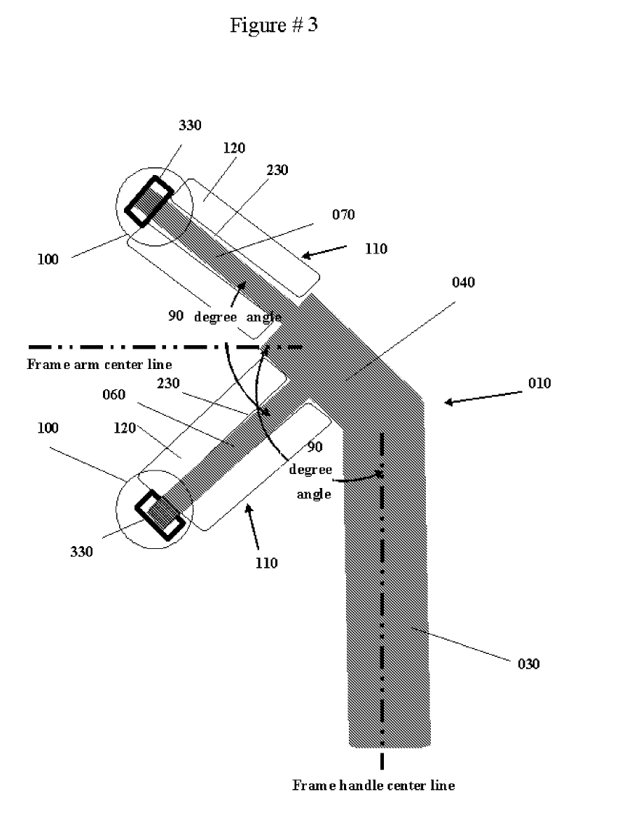

The frame 020, includes a frame handle 30, a frame handle & arm connection member 040, two frame arms 50, including a frame left arm 060 & a frame right arm 070, and a frame arm roller connection means 080. The frame arm roller connection means 080, is depicted in FIG. 1 & 5 as a frame arm barb connection end 090, while the frame arm roller connection means 080, is depicted in FIG. 3 & 7 as a frame arm threaded connection end 100, and in FIG. 2, 4, & 6 the frame arm roller connection means 080, is a press-fit between the frame arm 50 and roller 110.

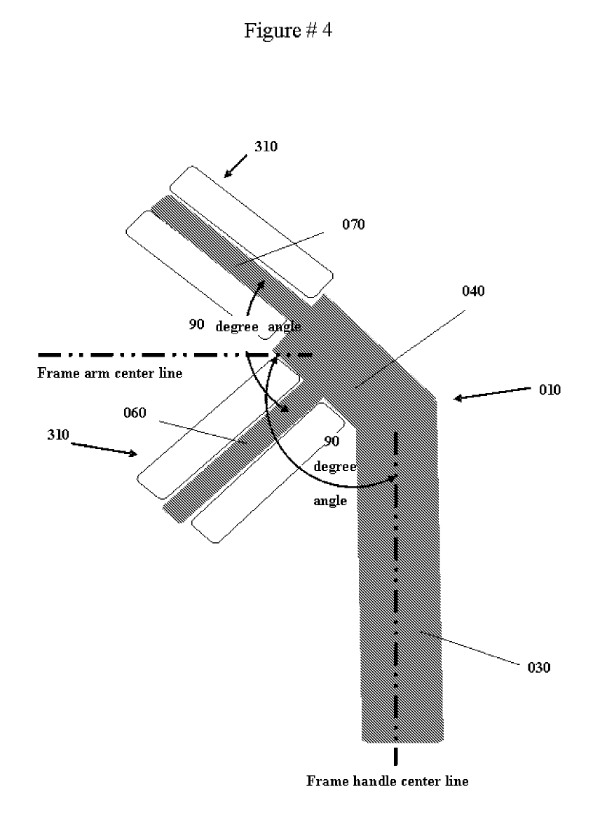

The roller 110, includes a roller material 120, and a roller core 230. The roller material 120, can be made from a plurality of materials comprising, roller painting material 130, roller staining material 140, roller sanding material 150, roller dusting material 160, roller polishing material 170, roller liquid chemical applying material 180, roller powder chemical applying material 190, roller stripping material 200, roller cleaning material 210, and roller print material for identification or labeling 220. The roller core 230, includes, a roller core inside surface 240, a roller core outside surface 250, a roller core hole 260. In FIG. 2, the roller core 230, has a roller core internal retainer 270, that acts as a spring forming a press-fit around the frame arm 50, to retain the roller 110. In FIG. 4 the roller core 230, has a roller core sleeve 280, which forms a press-fit with the frame arm 50, to retain the roller 100.

The roller 110, is easily attachable and detachable to the frame arm 50. The roller 110, with the desire roller material 120, is chosen for the specific coating applications.

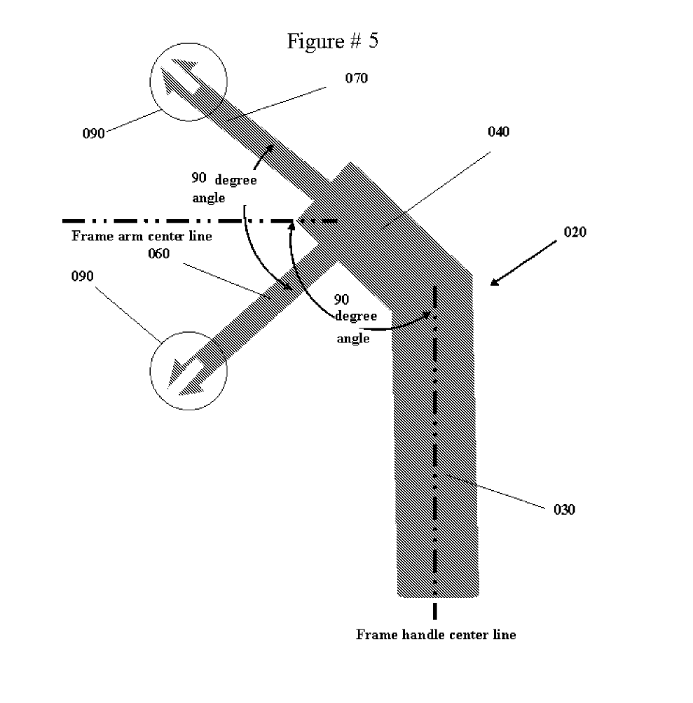

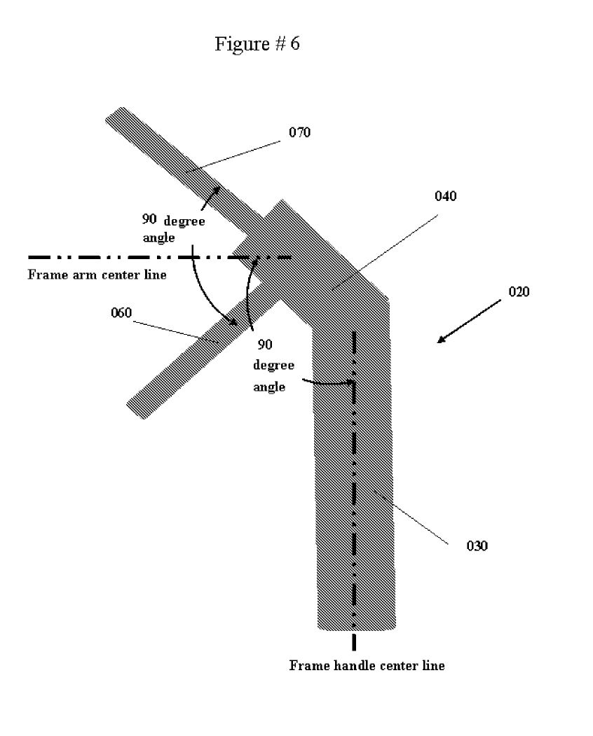

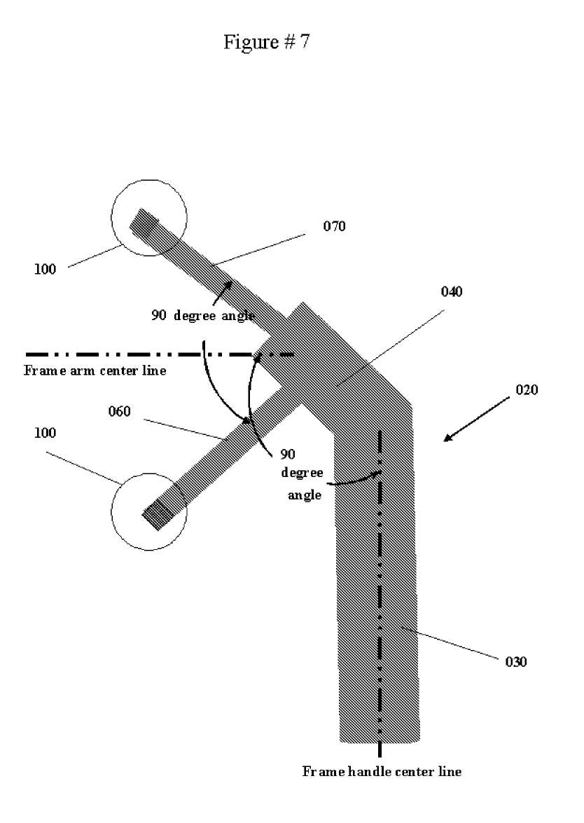

The preferred embodiment of the frame 020, is a one piece member shown in FIG. 5-7. The frame 020, can be manufactured in a plurality of ways comprising molded, machined, laser cut, water cut, plasma cut, wire EDM cut, die cut and stamped. The preferred method is injection molding due to the low cost for high volume. For low volume production machined, laser cut, water cut, plasma cut, wire EDM cut, die cut and stamped frames will be built. There are a plurality of materials the frame 020, can be made from comprising plastic, metal, and wood. The preferred material is plastic in high volume applications and metal or wood in low volume applications.

### Advantages

From the description above, a number of advantages of the “multisided roller brush” become evident:
(a) provides a way to concurrently paint, stain, dust, polish, strip, sand, clean, wipe off or apply chemicals (liquid and powder) to different sides around the surface area of multisided objects comprising of bars, posts, poles, shafts, spindles, railings, supports, and columns but not limiting to the aforementioned group of objects;
(b) provides a faster way to paint, stain, dust, polish, strip, sand, clean, wipe off or apply chemicals (liquid and powder) to multisided objects comprising bars, posts, poles, shafts, spindles, railings, supports, and columns but not limiting to the aforementioned group of objects;
(c) provides a more efficient way of painting, staining, dusting, polishing, striping, sanding, cleaning, wiping off or applying chemicals (liquid and powder) to multisided objects comprising bars, posts, poles, shafts, spindles, railings, supports, and columns but not limiting to the aforementioned group of objects;
(d) provides a cheaper way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(e) provides an easier way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(f) provides a simple way paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(g) provides a reduction in the number of people require to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(h) provides a better way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;

### Operation (Multisided Roller Brush)

The first step would be to determine what application you needed. This would determine which roller material you needed. If you were painting, staining, dusting, polishing, striping, cleaning, wiping off & applying chemicals (liquid and powder), drying, sanding, or scraping each of theses different operations would require you to pick out a roller that has the specific roller material that is typically used for that specific application. Once you have decided what roller you need for the specific job, such as needing a painting roller material for painting porch railing, you would then be ready to start using the “multisided roller brush”.

An operator would put the frame handle of the “multisided roller brush” in the palm of his hand and wrap his fingers around the frame handle. Push the specific roller onto the frame arms.

While holding the “multisided roller brush”, dip the rollers into the paint, stain, polish, stripping compound, or other chemicals (liquid and powder). Shake, wipe off excess coating on rollers or use a surface with a 90 degree edge to roll coating onto, to ensure uniform coating is left on the rollers without coating dripping from the rollers. If it is a dusting, sanding or wiping operation where no coating will be applied to a multisided object then there will be no need to dip the rollers into a substance or coating. Place the roller opening around a multisided object. After the roller opening is around the multisided object, proceed to move along the right surface area length of the multisided object to ensure that the rollers are applied around a 180 degree section of the entire surface area length of the multisided object.

As you use the handle to apply pressure against the multisided object with the multi-head, the multi-rollers will rotate as you move up and down along the surface area length of the multisided object. Then while standing on the same side of the multisided object, flip the multi-head opening so that the opening is in the opposite direction. Then proceed to roll along the opposite, right, surface area length of the multisided object to ensure that the coating is being applied to the other 180-degree section of the surface area length of the multisided object.

The roller material should form a loop around the multisided object allowing you to apply liquid or powder to part or all of the surface area of the of the multisided object. Sometime it may be necessary to flip the “multisided roller brush” over causing the roller opening to face the opposite direction so that the other sections of the multisided object can also be acted upon by the rollers. This application can be repeated until the entire surface area of the multisided object, 360 degrees around, is covered by the rollers ensuring that the liquids or powder on the rollers is applied to the multisided object complete surface or if no chemicals are used the roll material has acted on the entire surface of the multisided object. This can all be done from standing on one side of the multisided object.

In the dusting, drying, sanding and surface stripping applications the same process as above is repeated except there is no liquid or power being applied to the multisided object. The roller material of the multi-roller is only being applied to the surface area of the multisided object and these different roller materials act on the object to dust, dry, sand and strip the surface area of the multisided object. This process is repeated until the entire surface area of the multisided object, 360 degrees around the entire surface area of the object is dusted, dried, sanded, or stripped.

### Conclusions, Ramifications, and Scope

Accordingly, the reader will see that the “multisided roller brush” of this invention has advantages in that
(a) it provides a way to concurrently paint, stain, dust, polish, strip, sand, clean, wipe off or apply chemicals (liquid and powder) to different sides around the surface area of multisided objects comprising of bars, posts, poles, shafts, spindles, railings, supports, and columns but not limiting to the aforementioned group of objects;
(b) it provides a faster way to paint, stain, dust, polish, strip, sand, clean, wipe off or apply chemicals (liquid and powder) to multisided objects comprising bars, posts, poles, shafts, spindles, railings, supports, and columns but not limiting to the aforementioned group of objects;
(c) it provides a more efficient way of painting, staining, dusting, polishing, striping, sanding, cleaning, wiping off or applying chemicals (liquid and powder) to multisided objects comprising bars, posts, poles, shafts, spindles, railings, supports, and columns but not limiting to the aforementioned group of objects;
(d) it provides a cheaper way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(e) it provides an easier way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(f) it provides a simple way paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(g) it provides a reduction in the number of people require to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(h) it provides a better way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;

Further objectives and advantages of my invention will become apparent from a consideration of the drawings and ensuing description.

Although the description above contains much specificity, these should not be construed as limiting the scope of the invention but as merely providing illustrations of some of the presently preferred embodiments of the invention. For example, the frame and rollers can take on many shapes comprising circular, oval, trapezoidal, triangular, and angled. They can be attached in a variety of ways comprising bolted, screwed, welded, molded, stapled, glued, tacked, crimped, snap fitted, press fitted and riveted. They can be made out of various material comprising steel, aluminum, brass, plastic, wood, nylon, polyurethane, polyester, and synthetics.

Thus the scope of the invention should be determined by the appended claims and their legal equivalents, rather than just by the examples given.

I claim:

1-9. (canceled)

10. A nonadjustable multisided roller unit that is disposable, very inexpensive, can easily be mass produced comprising a completely uniform plastic solid single piece nonadjustable and non-detachable roller frame manufactured to completely lie in one geometric plane
wherein said nonadjustable and non-detachable roller frame comprises a handle for an operator to hold onto during operation and comprises two angled rods for a roller cover to rotate around the outer diameter of said angled rods where said angled rods extend from said handle and where said handle and said angled rods are nonadjustable and non-detachable from said nonadjustable and non-detachable roller frame
wherein said nonadjustable and non-detachable roller frame is manufactured in one geometric plane from processes comprising plastic injection molding, rapid prototyping or die cut out of a sheet of plastic so that all of said nonadjustable and non-detachable roller frame is manufactured as one single uniform nonadjustable and non-detachable solid
wherein said angled rods each can have a built in quick release slotted barb tab wherein a roller cover can quickly be slipped on and off of the outer diameter of each said angled rods for retention during operation
wherein said angled rods each can have a built in end cap wherein said roller covers can be permanently retained on said angled rods without the ability to become removed from said nonadjustable and non-detachable roller frame causing the roller frame and covers to both be disposed of together after use
wherein multisided objects comprising bars, posts, spindles, legs, arms, poles, railings, columns and shafts can be surrounded by said roller covers on said nonadjustable multisided roller unit while standing in one spot from one side of said multisided object wherein when the top and bottom of said multisided objects are contained and trapped between two permanent members not allowing entrance from the top or bottom of said multisided objects said nonadjustable multisided roller unit can still enter and surround 360 degrees around said multisided objects from the middle section of the objects allowing for painting, staining, dusting, polishing, striping, sanding, cleaning, and wiping off or applying liquid and powder chemicals to said bars, posts, spindles, legs, arms, poles, railings, columns and shafts by surrounding 360 degrees around said middle section of said multisided objects with said roller covers which is allowed because of said nonadjustable multisided roller unit being manufactured to lie in only one horizontal geometric plane allows for entrance to said middle section of said multisided objects when top and bottom entrance of said multisided object is not permissible
wherein said roller covers comprises a roller material, and a roller core that is formed in the shape of a tube with a hollow inside such that said roller core can rotate around the outer diameter of said angled rods
wherein said roller material is selected from the group comprising steel, stainless steel, brass, bronze, aluminum, nylon, plastic, polyester, polypropylene, African bass, bassinc, bristle, camel hair, goat hair, horse hair, ox hair, pony hair, palmyra, red sable, sabline, tampico, union fibre, sponges, foam, sandpaper, feathers, rubber, chain bristles, cloth, cotton, and foam filler material.
